(19) United States
(12) Patent Application Publication
(10) Pub. No.: US 2006/0167717 A1
(43) Pub. Date: Jul. 27, 2006

(54) System and method for listing and finding goods and services over the internet

(76) Inventor: Roger M. Desenberg, Sarasota, FL (US)

Correspondence Address: OSTROLENK FABER GERB & SOFFEN, 1180 AVENUE OF THE AMERICAS, NEW YORK, NY, 100368403, US

(21) Appl. No.: 11/342,203

(22) Filed: Jan. 27, 2006

Related U.S. Application Data
(60) Provisional application No. 60/647,681, filed on Jan. 27, 2005.
(60) Provisional application No. 60/652,666, filed on Feb. 14, 2005.
(60) Provisional application No. 60/695,730, filed on Jun. 30, 2005.

(51) Int. Cl. G06Q 99/00

(52) U.S. Cl. 705/1

(57) ABSTRACT

The present invention provides an improvement over prior art search engine techniques in various ways. In one embodiment, the present invention provides a system and method for enabling searchers to locate content stored on an Internet web site. A user interface is preferably provided that is operable to receive from a workstation electronic information representing, for example, the content stored on the web site. Thereafter, computer programming code is automatically generated as a function of the electronic web site information and the code is provided to the workstation. The code, preferably formatted as HTML, enables searchers to locate the content when the code is stored on the web site.

### CROSS-REFERENCE TO RELATED APPLICATIONS

The present application is based on and claims priority to U.S. Provisional Patent Application Ser. No. 60/647,681, filed on Jan. 27, 2005 and entitled “SEARCH ENGINE,” U.S. Provisional Patent Application Ser. No. 60/652,666, filed on Feb. 14, 2005 and entitled “IMPROVED SYSTEM AND METHOD FOR LISTING AND FINDING GOODS AND SERVICES OVER THE INTERNET II,” and U.S. Provisional Patent Application Ser. No. 60/695,730, filed Jun. 30, 2005 and entitled “IMPROVED SYSTEM AND METHOD FOR LISTING AND FINDING GOODS AND SERVICES OVER THE INTERNET II,” the entire contents of all of which are hereby incorporated by reference.

### BACKGROUND OF THE INVENTION

1. Field of the Invention

The present invention relates to search engine technology and, more particularly, to a system and method for indexing Internet web sites and improving methods of searching therefor.

2. Description of the Related Art

Prior art search engine technology maintains the status quo with respect to the way Internet users search Internet web sites in order to locate goods and services offered by various organizations. Prior art search engines typically employ a one-question approach to searching, which is inherently limiting. For example, a searcher is provided a text-box or other graphic screen control in which to enter one or more “keyword” search terms representing Internet web sites the user wishes to locate. After submitting the terms, typically by selecting a graphically screen control, such as a button, the search engine uses the key words to search a database of web sites and corresponding descriptions, to locate web sites that most closely match the submitted keywords.

A typical prior art search engine generates a list of Internet web sites in response to the user's submission. Depending upon the keywords, the returned list may include thousands and thousands of web site listings. Alternatively, the list may return very few results, which often indicates that the scope of the keyword search is too narrow. Interestingly, many searchers typically believe that the more listings they receive the better. However, since it is effectively impossible to review thousands of the listings returned by such a search, it is believed by the inventor that most searchers review fewer than 1% of all listings that are returned by a search engine. Accordingly, users are exposed to a very small percentage of web sites on the Internet, and, therefore, it is believed that prior art Internet search engine technology impedes progress, maintains the status quo and decreases the effectiveness of the ability to locate quality information. Such an inefficiency is further believed to reduce drastically the overall gross international product, as well as the total revenue generated by business conducted over the Internet.

Another shortcoming of prior art techniques to locate goods and services over the Internet is the lack of an ability for providers to inform the Internet community of available goods and services. For example, search engines use so-called software robots, known as “spiders” or “crawlers,” that use automated processes to visit Internet web sites and typically gather information about the web sites, such as by analyzing the sites' hypertext mark-up language (“HTML”). That information is used to index the web sites in a database provided by the search engine. Alternatively, a proprietor of an Internet web site submits information regarding his web site in an on-line form provided by a search engine in order to inform the search engine of the proprietor's web site. It is believed by the inventor that such prior art techniques fall far short of what is needed to enable searchers to locate content on Internet web sites that provide goods and/or services.

Referring now to the drawings, in which like reference numerals refer to like elements, there is shown in FIG. 1 an example of a typical prior art hardware arrangement of computing devices that communicate with Internet search engines over a communication network, and referred to herein, generally, as system 100.

In the typical environment shown in FIG. 1, search engines 102 receive search requests for sources of content from user workstations 104 over communication network 105. Network 105 can be any communication network, and preferably is a global communication network such as the Internet. In response to the search requests, search engines 102 provide search results to workstations 104 that include links to web sites provided by respective on-line content providers, for example, web servers 106.

Unfortunately, prior art search engine technology is often applauded by the business industry as being very efficient and useful. Although popular search engines may appear effective when a searcher receives a listing that includes a particular web site he or she is looking for, too often is the case that searchers are not presented with alternative web sites, or simply do not review web sites that may be more suitable due to the vast number of web sites returned by the search.

It is also believed that the process most search engines use to index their databases is inefficient. Virtually all search engines use some form of software robots that automatically retrieve HTML code directly from an Internet web site. For example, text presented on a web site may be used as an index in a database, and the web site address is categorized based on that index. In essence, there is one iteration: the web site is identified, and a database record is indexed and added.

### SUMMARY OF THE INVENTION

The present invention provides an improvement over prior art search engine techniques in various ways. In one embodiment, the present invention provides a system and method for enabling searchers to locate content stored on an Internet web site. A user interface is preferably provided that is operable to receive from a workstation electronic information representing, for example, the content stored on the web site. Thereafter, computer programming code is automatically generated as a function of the electronic web site information and the code is provided to the workstation. The code, preferably formatted as HTML, enables searchers to locate the content when the code is stored on the web site.

In an other embodiment, the present invention enables a proprietor of a web site to post information related to a good or service that the proprietor is looking to buy or sell. In this embodiment, an interface is provided that is operable to receive electronic information over a communication network from a workstation. The interface preferably receives electronic posting information that represents at least the good or service that the proprietor is looking to buy or sell. Computer programming code, preferably formatted as HTML, is preferably automatically generated as a function of the electronic posting information, and the code is provided to the workstation. The code provides the information to be posted and enables searchers offering to sell or buy the good or service to locate the proprietor.

Other features and benefits of the present invention are described in detail, below.

### BRIEF DESCRIPTION OF THE DRAWING(S)

For the purposes of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 is an illustration of a typical prior art hardware arrangement of computing devices that communicate with Internet search engines over a communication network;

FIG. 2 is an illustration of an example art hardware arrangement of computing devices that communicate with Internet search engines over a communication network in accordance with an embodiment of the present invention;

FIG. 3 is a block diagram illustrating the functional elements in an example information processor;

FIGS. 4A-4F illustrate example display screens that are provided to proprietors of Internet web sites to generate information regarding their sites, in accordance with a preferred embodiment of the present invention;

FIGS. 5A-5E illustrate example display screens that are provided to proprietors and/or searchers of Internet web sites to generate information regarding their goods and/or services they desire purchase or sell;

FIG. 6 is a flow chart that illustrates steps associated with indexing an Internet web site in accordance with a preferred embodiment of the present invention;

FIG. 7 is a flow chart that illustrates steps associated with searching for web sites in accordance with a preferred embodiment of the present invention; and

FIG. 8 is an example display screen that is provided to a searcher searching for Internet web pages in accordance with an example embodiment of the present invention.

### DETAILED DESCRIPTION OF EMBODIMENTS OF THE INVENTION

The present invention provides various features that improve prior art search engine technology, and includes various features and embodiments, examples of which are provided below.

In accordance with one embodiment of the present invention, an iterative system and method is provided in which a search engine (e.g., via a “crawler”) discovers a web site to visit, establishes a connection with the web site, and indexes the information contained therein, substantially as described above with respect to the prior art. After information regarding the web site is collected and used to index the web site, for example, a making a new database entry, the present invention preferably contacts the administrator of the web site, for example by e-mail, to pose one or more questions about the web site in order to index the web site (and its associated content) more accurately. It is believed by the inventor that administrators of web sites have an incentive to reply to the questions in order to steer traffic to their web sites, especially since such traffic will include parties that searched for the content provided on the web site. Referred to herein, generally, as “optimized” search traffic, the present invention preferably improves prior art searching methods by steering traffic to web sites that is more germane to the proprietor than traffic often sent to web sites via prior art search engines. Similar to the above-identified misconception by searchers that more web site listings returned by a search engine is better, there exists a similar misconception by proprietors of web sites that more traffic to a web site is better, when the right traffic is what is needed for success. For example, visitors to a web site who do not make use of the services or products offered for sale on a web site may not be of much value to the proprietor of the web site. The present invention improves upon the prior art by providing accurate categories and classifications of web sites which are used to increase the likelihood that Internet searchers will locate the web sites they desire and, accordingly, web site proprietors will receive the traffic they desire.

As used herein, the terms “proprietor,” “administrator,” “owner” (or the like) of web sites refer, generally, to one or more persons who are authorized to exercise control over the contents and/or programming code of an Internet web site. A web site administrator, for example, may be employed by a corporation to manage information regarding the web site, including tags or other embedded codes in the web site. A web site proprietor may be responsible for the contents displayed in the web site, as well as the graphical layout and appearance of the web site. One skilled in the art will recognize that a proprietor of a web site, as generally used herein, may direct a programmer or web site developer to implement an Internet web site according to specific instructions.

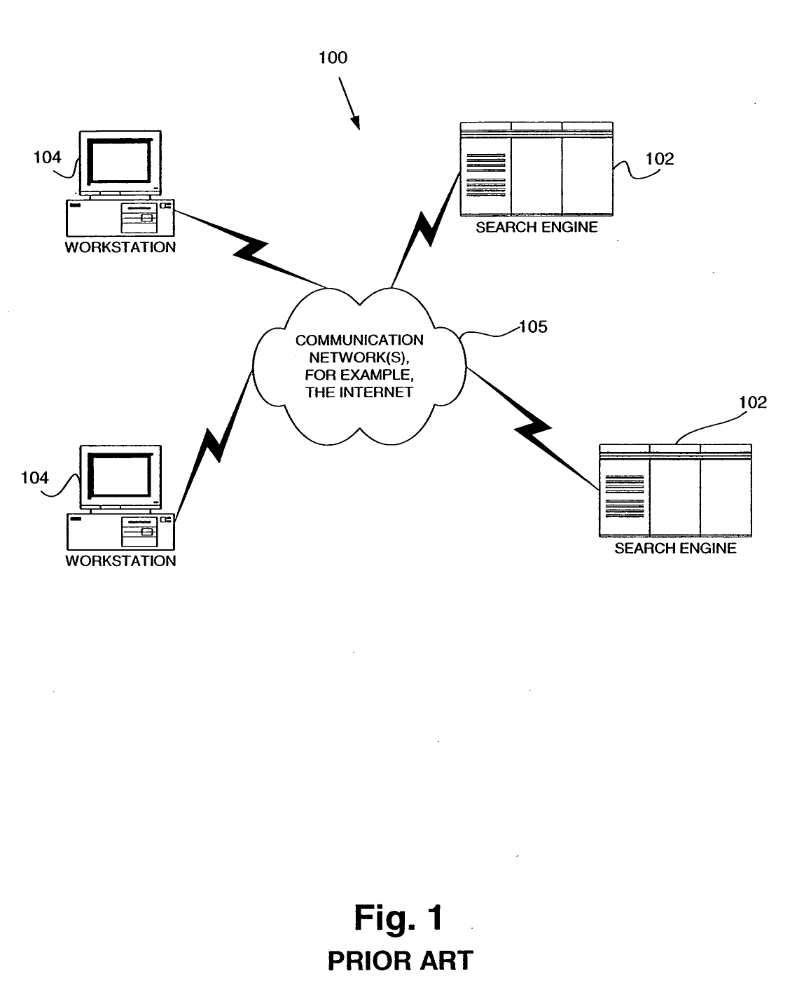

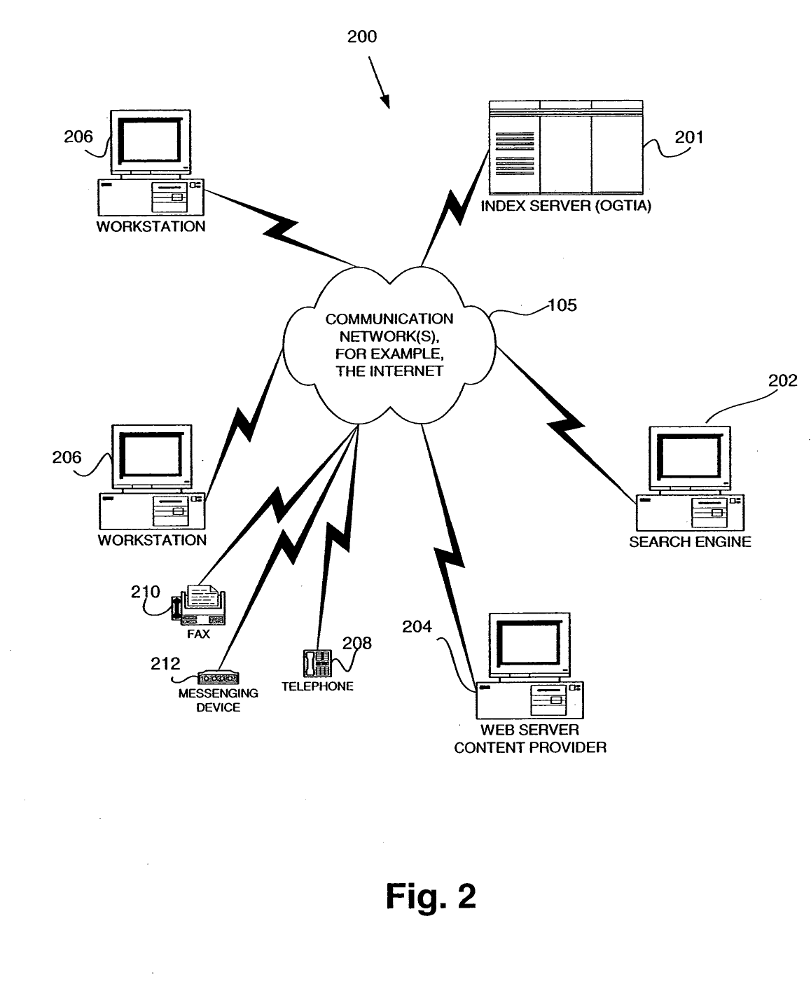

Referring now to FIG. 2, an arrangement of hardware devices provided in accordance with the present invention referred to herein, generally, as search system 200. As shown in FIG. 2, index server 201, Internet search engine 202, web server 204 and user workstation 206 operate and/or communicate over communication network 105. In addition, various communication devices, such as telephone 208, fax machine 210, pager/messaging device 212 are illustrated. Communication devices 208-212 enable parties to the present invention to receive and send messages on a plurality of platforms, in addition to computing devices 202-206. Many of the hardware devices illustrated comprising search system 100 are the same as those illustrated in FIG. 1. Unlike system 200, however, search system 200 preferably provides software and/or hardware elements that enable utilize features described herein.

Index server 201 preferably also functions as a web server to provide a web site that preferably enables proprietors of web servers to generate HTML web pages to be used by search engine 202 or other web site retrieval device/application. Index server 201, search engine 202 , web server 204 and user workstation 206 can be any devices that are capable of sending and receiving data across communication network 105, e.g., mainframe computers, mini computers, personal computers, laptop computers, personal digital assistants (PDA) or Internet access devices such as Web TV. In addition, user workstation 206 are preferably equipped with a web browser, such as MICROSOFT INTERNET EXPLORER, NETSCAPE COMMUNICATOR, MOZILLA FIREFOX and the like. Search engine 202, web server 204 and user workstation 206 are coupled to communication network 105 using any known data communication networking technology.

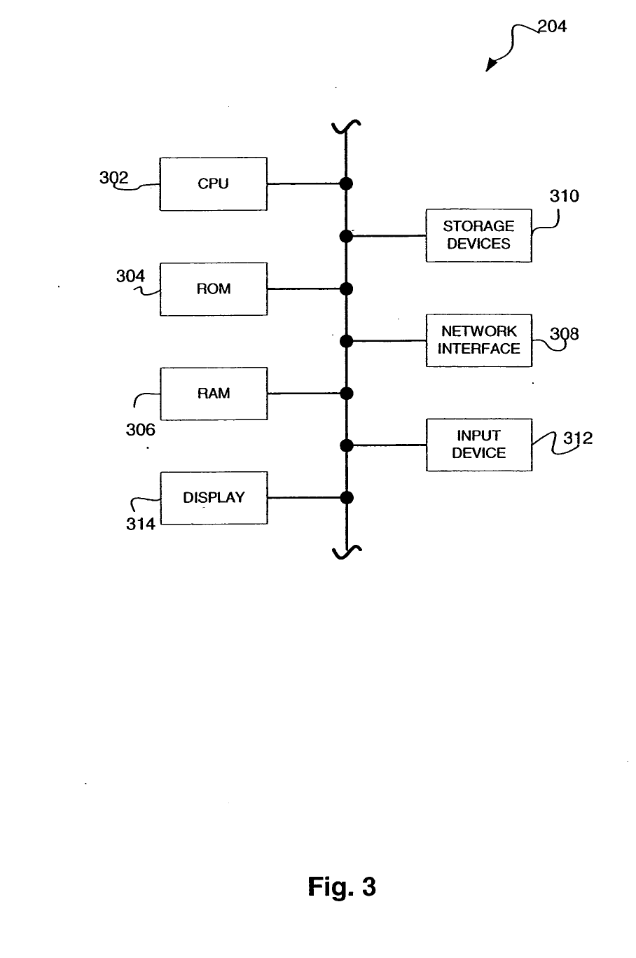

As shown in FIG. 3, the functional elements of each web server 204 include one or more central processing units (CPU) 302 used to execute software code and control the operation of web server 204, read-only memory (ROM) 304, random access memory (RAM) 306, one or more network interfaces 308 to transmit and receive data to and from other computing devices across a communication network, storage devices 310 such as a hard disk drive, floppy disk drive, tape drive, CD ROM or DVD or storing program code, databases and application data, one or more input devices 312 such as a keyboard, mouse, track ball, microphone and the like, and a display 314.

The various components of web server 204 need not be physically contained within the same chassis or even located in a single location. For example, storage device 310 may be located at a site which is remote from the remaining elements of web server 204, and may even be connected to CPU 302 across communication network 105 via network interface 308.

Web server 204 may be equipped with sufficient storage to provide the necessary databases and other services described herein, as well as acting as a web server for communicating hypertext markup language (HTML), XML, Java applets, Active-X control programs or the like, to workstations 206. For example, when a user of workstation 206 activates web browser software, he is connected to web server 204 which functions as a HTTP server and provides HTML content. Preferably, web server 204 is arranged with components, for example those shown in FIG. 3, suitable for the expected operating environment of web server 204. The central processing unit(s) 302, network interface(s) 308 and memory and storage devices are selected to ensure that capacities are arranged to accommodate expected demand.

The functional elements shown in FIG. 3 (designated by reference numerals 302-314) for web server 204 are of the same categories of functional elements also present in workstations 206 and search engines 202. However, not all elements need be present in all workstations 206 in the same size and configuration. For example, CPU 302 in workstation 206 is typically a smaller capacity CPU than the CPU present in the web server 204. Similarly, it is likely that the web server 204 will include storage devices of a much higher capacity than storage devices present in workstation 206.

Of course, one of ordinary skill in the art will understand that the capabilities of the functional elements can be adjusted as needed. The nature of the invention is such that one skilled in the art of writing computer executable code (software) can implement the described functions using one or more or a combination of a popular computer programming languages including, but not limited to C++, Visual Basic, Java, Active-X, HTML and web application development environments.

Although the present invention is described by way of example herein and in terms of a web-based system using web browsers and a web site server (web server 204), system 200 is not limited to the above configuration. It is contemplated that system 200 can be arranged such that workstations 206 can communicate with and display data received from web server 204 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on workstation 206, for example, WINDOWS 3.x, WINDOWS 95, WINDOWS 98, WINDOWS NT, WINDOWS MILLENNIUM, WINDOWS 2000, WINDOWS XP, WINDOWS CE, Mac OS, UNIX, LINEX, Palm OS and any suitable PDA or palm operating system.

As used herein, references to displaying data on workstation 206 refers to the process of communicating data to the terminal across communication network 105 and processing the data such that the data is viewed on the displays 314 using a web browser or the like. As is common with web browsing software, the display screen on workstations 206 present sites within the search system 200 such that a user can proceed with from site to site within the system by selecting a desired link.

Also as used herein, the term, “module,” refers, generally, to one or more discrete components that contribute to the effectiveness of the present invention. Modules can include software elements, including but not limited to functions, routine, algorithms, classes, subclasses and the like. Modules may also include hardware elements, substantially as described below. Modules can operate independently or, alternatively, depend upon one or other modules in order to function.

According to the present invention, a user interface is provided for searching Internet web sites. The user interface is preferably provided on search engine 202, but (as understood by one skilled in the art), may be provided on other devices, such as workstation 206, via a web browser toolbar or other software component. Preferably, a text box or other graphical screen control is provided to a user for entering one or more keywords to be used to search for Internet web sites. After a user desiring to locate a particular web site, referred to herein, generally, as a “searcher,” submits key words, for example, by selecting an icon in the form of a button, the search engine returns a listing of web sites, and, unlike prior art search engine 102, further provides one or more questions to the searcher in order to further refine the search criteria. For example, a searcher who is searching for refrigerators is prompted by the search engine to enter a particular make and model, price, size and purpose for the refrigerator. The questions are preferably generated using the criteria from the information previously received from web site administrators, as described below. In this way, searchers who are searching the Internet are provided opportunities to refine their searches and are more likely to be provided with web sites that offer the kinds of goods, services and information that they are seeking.

Another feature of the present invention includes an iterative process for refining the classifying and indexing of web sites, such that the process for refining web sites criteria preferably repeats one or more times in order to ensure accuracy. For example, the administrator of a web site replies to an e-mail prompting the administrator for information regarding the web site he or she administers. Thereafter, the present invention performs an evaluation of the administrator's reply to determine whether sufficient information has been received. In the event that the search engine determines more information may be required, the process repeats and the administrator is sent another message, for example by e-mail, requesting additional information.

Moreover, the searcher who uses the search engine of the present invention may also be prompted to refine search criteria more than once. Continuing with the above example regarding an Internet-based search for refrigerators, the searcher who submits a keyword search for refrigerators may initially receive a list of over 10,000 web sites. In accordance with the present invention, the searcher is provided one or more questions regarding the make, model, size and other preferences of the refrigerator. In one embodiment, when the searcher responds to such prompt(s) (e.g., the size of the refrigerator), the present invention preferably returns a smaller, refined list of web sites and may prompt for additional information, such as the amount of money the searcher wants to spend, the preferred make and model, or the like. In this way, the present invention provides an iterative approach to indexing web sites as well as searching for web sites that improves upon prior art search engine technology and increases the effectiveness of searches and removes the impediments to progress for the entire Internet industry.

Features of the present invention are now described that enable proprietors of Internet web sites to submit information regarding their sites and goods and/or services they provide for indexing purposes. In a preferred embodiment, the present invention provides an Internet web site for a proprietor of an Internet web site to visit that includes a series of prompts (such as those described above). In reply to the prompts, the proprietor preferably submits information regarding his web site which is used by the present invention, for example, for indexing purposes.

In a preferred embodiment of the present invention, a proprietor establishes a communication session with an Internet web site that includes graphical screen controls operable to receive information regarding the proprietor's site. After the proprietor submits information regarding his site, programming code preferably formatted as HTML is automatically generated that includes the respective information submitted by the proprietor. Thus, using a web based data entry form, HTML code is automatically generated that can be interpreted by standard Internet web browser software and used for enabling Internet-based searchers to locate the proprietor's web site. For example, a complete HTML web page that includes various tags (i.e., title tag, body tag and the like) is automatically generated. In an alternative embodiment, programming code is generated that can be interpreted by some other automated process to index the proprietor's web site accurately.

Preferably, after the HTML code is generated by the present invention, the user is prompted to save the HTML code in a file that is named in a uniform way in accordance with other web site proprietors. Moreover, the proprietor is preferably prompted to store the file in a directory under a, for example, the web site root directory that is similarly named in a uniform way. For example, the file is formatted to be named “OGTIA.HTM” (or “OGTIA.HTML”) and is preferably stored in a sub-directory named “OGTIA.” In an alternative embodiment of the present invention, the HTML file will include in the title tag (“<title>”) a unique code, such as 7**7. By including such a unique code, search engines will filter out other OGTIA related web pages, and return genuine OGTIA Listings. Thus, users who include language in web pages related to OGTIA (or other identifier representative of the teachings herein), search engines will omit those listings.

Of course, one skilled in the art will recognize that any name can be used in a particular HTML tag, file name and/or directory name provided that the name complies with Internet naming convention rules, and is applied uniformly. Thereafter, search engines or other web sites that assist searchers to locate content on Internet web sites preferably search through the “OGTIA.HTM” file (in the OGTIA sub-directory) in order to identify information regarding the proprietor's web site. In this way, the proprietor is responsible for maintaining information regarding his web site, and is not limited to relying on prior art search engine technology to classify and/or categorize his web site.

For example, a proprietor of an Internet web site desires to sell his used luggage over the Internet. In accordance with a preferred embodiment of the present invention, the proprietor establishes a communication session with the indexing web site of the present invention, and submits information regarding the used luggage offered for sale. The indexing web site receives the proprietor's data entry and generates HTML code that includes descriptions regarding the luggage. Thereafter, the HTML is saved and stored in a uniform way such that the proprietor's web site and luggage for sale (even if unrelated to the content provided on the proprietor's web site) can be discovered by searchers over the Internet. For example, the proprietor's web site may be directed to informational content (e.g., insurance information), which is unrelated to used luggage. The present invention enables searchers to find the used luggage, in part due to the uniform file and directory naming rules.

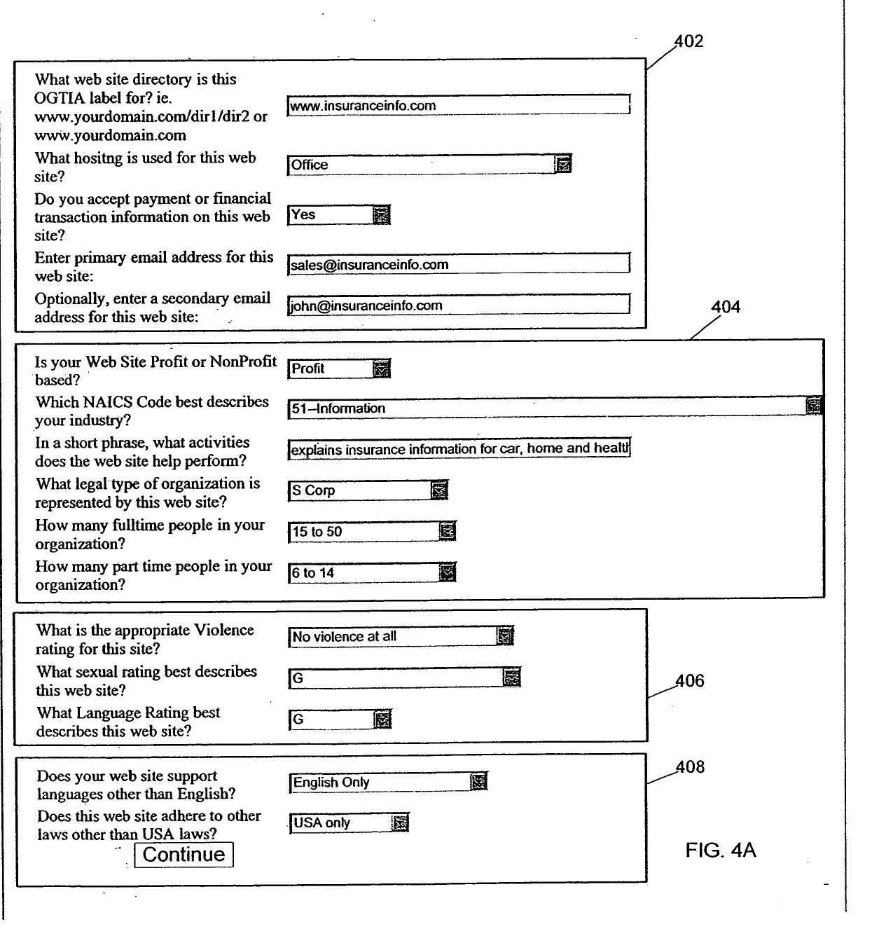

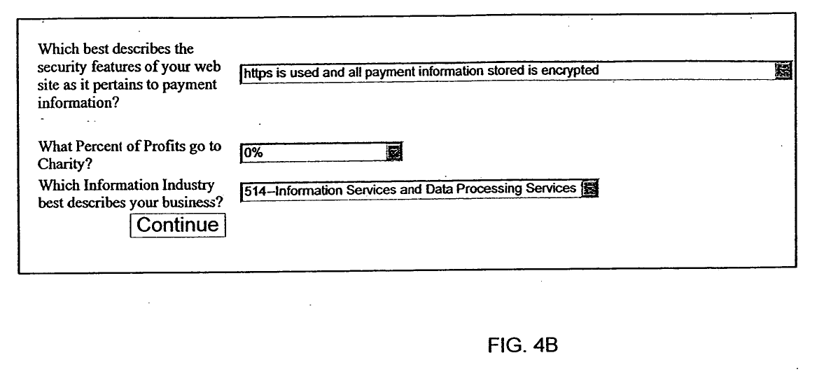

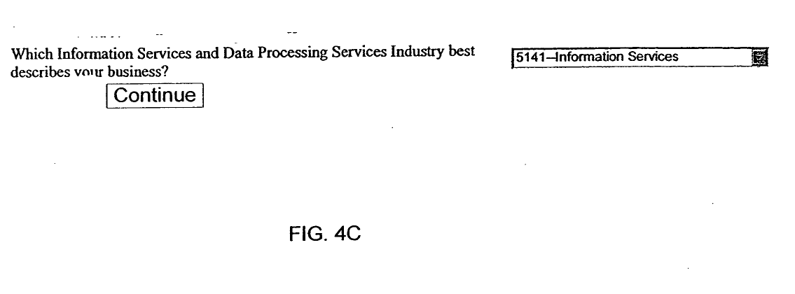

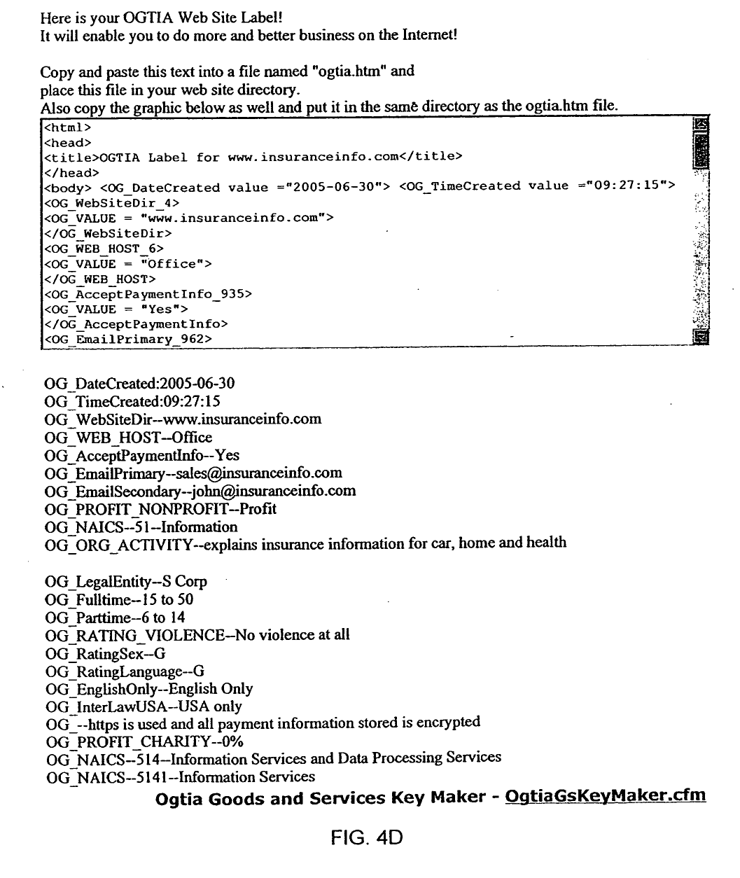

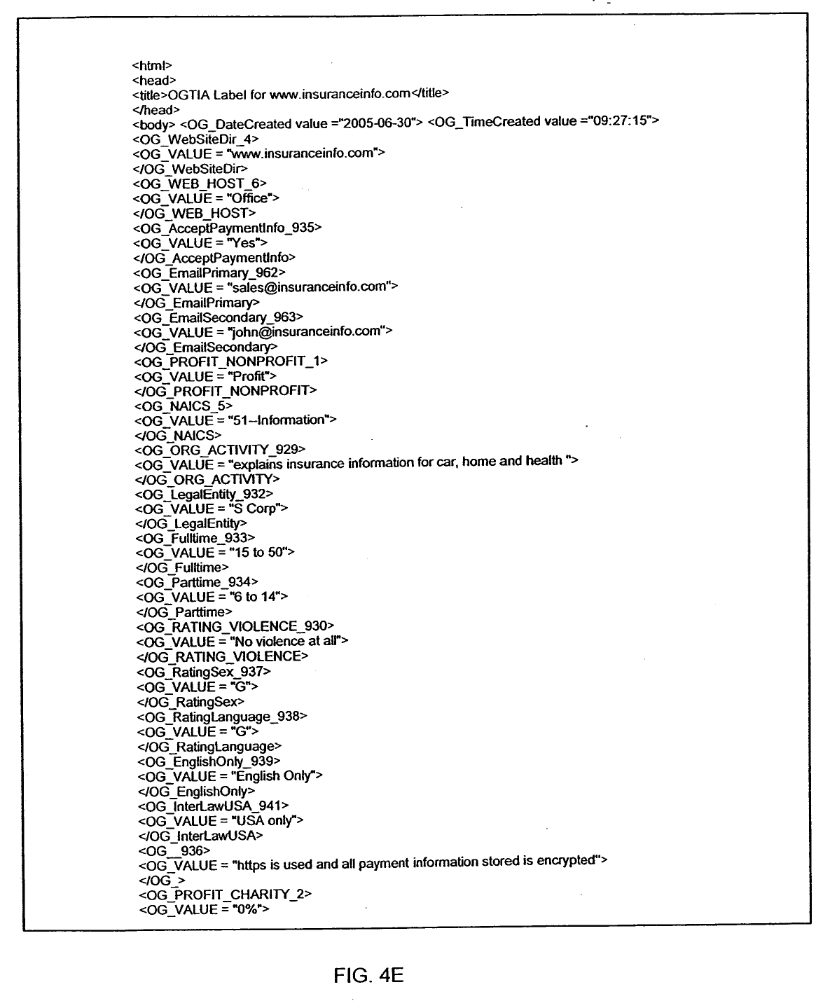

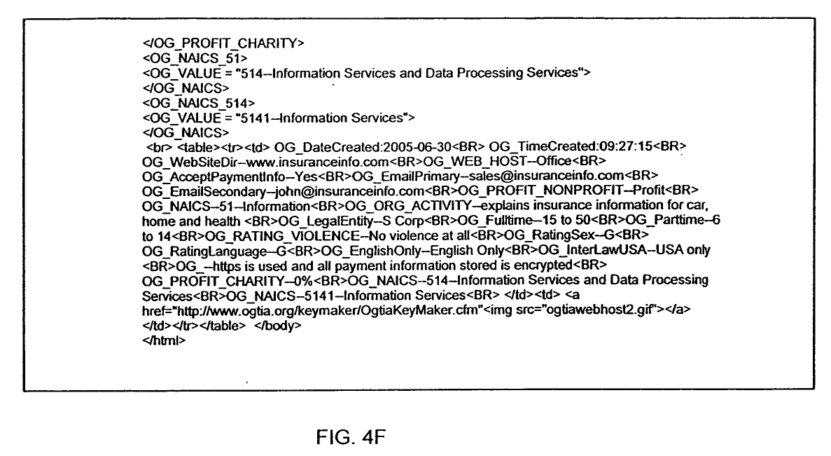

FIGS. 4A-4F illustrate an example embodiment of the present invention in which a proprietor of a web site connects to an Internet web site provided by the present invention to submit information regarding the proprietor's web site. As shown in the example embodiment in FIG. 4A, four general types of information are submitted by the proprietor of the web site that includes web site security section 402 that provides for general web site information, organization type section 404 that provides for general information regarding the proprietor's business. Further, ratings section 406 provide for rating with respect to the degree of graphic nature of the content, and the web site and national information section 408, that includes language and information regarding legal jurisdiction. As described in greater detail below, the present invention uses the information submitted by the proprietor in order to generate code, referred to, generally, as an “OGTIA Label” in the drawings, that is used by searchers to locate the proprietor's web site. A directory name is further identified by the proprietor which will contain the OGTIA Label for future use.

Regarding web site security section 402, information submitted by the proprietor in the general web site portion of FIG. 4A includes the type of hosting used for the web site, whether payment or financial transaction information is accepted by the web site, and primary and secondary e-mail addresses (e.g., the proprietor's e-mail address). With respect to organization type, section 404, the proprietor is prompted to submit whether the web site is for profit or not for profit, a particular North American Industry Classification System (“NAICS”) code that describes the industry represented by the web site, a short phrase that describes the activities performed by the web site and the legal type of organization represented by the web site, including whether the organization represented by the web site is a corporation or a partnership. In the example shown in FIG. 4A, the proprietor submits the NAICS Code is 51, for information. Also the proprietor is prompted to enter the number of full time and part time people employed by the organization. With respect to ratings section 406 and nationality information section 408, the proprietor is preferably prompted to rate the violence, sexual and language rating of the web site. Further, the proprietor is prompted to submit whether other languages are supported besides English and further whether there are other foreign jurisdictions or laws that the web site adheres to.

FIG. 4B includes prompts for the proprietor to submit web site security information, including the types of security features for payment information, and further whether the web site includes any percentage of profits that go to a charity. Further, the proprietor is prompted to identify a retail trade industry that best describes the business represented by the web site.

FIG. 4C shows a prompt for the proprietor to submit information regarding the organization represented by the web site in accordance with the previously submitted NAICS Code (FIG. 4A). For example, in FIG. 4B, the proprietor submits that the information industry is section 514, information services and data processing services. In FIG. 4C, the proprietor is prompted to enter, pursuant to information services and data processing services, an additional description. The proprietor submits value 514 (Information Services) in the example shown in FIG. 4C.

FIG. 4D illustrates the generation of the label after the proprietor has submitted information regarding his web site. As shown in FIG. 4D, HTML programming code has been generated automatically by the present invention. In the example shown in FIG. 4D, HTML is generated in a text box and the proprietor is prompted to copy and paste the text into a new file named OGTIA.HTM, and to place the file in the web site identified in FIG. 4A. Of course, one skilled in the art will recognize that the invention is not so limited, and that the generation of HTML can be saved automatically in accordance with a predefined file name or a file name that is identified by the proprietor of the web site and automatically stored in a predefined directory or directory identified by the proprietor. Further, as shown in FIG. 4D, the responses to the prompts that were made by the proprietor of the web site are identified below the text box containing the programming code generated by the present invention. In this way, the proprietor can review how his entries have been received.

FIGS. 4E and 4F illustrate sample programming code that is generated by the present invention. As will be recognized by one skilled in the art, a complete HTML web page is generated by the present invention. Of course, one skilled in the art will recognize that the example HTML illustrated in FIGS. 4E and 4F is merely illustrative, and that the code may be formatted in countless ways and/or languages in order to implement the features and teachings herein.

Thus, in accordance with a preferred embodiment of the present invention, a proprietor of a web site submits descriptive information about the proprietor's supply and demand, and programming code, preferably in the form of HTML, is generated. The programming code is preferably used for indexing purposes such that a search engine or other retrieval device can substantially automatically retrieve the information in the HTML or other programming code to provide searchers with various web sites in accurate and optimized search result listings. The information stored in the HTML or other programming code is preferably used, in one embodiment, by search engines on the Internet to ensure that searchers who are searching for particular Internet web sites are provided accurate listings of Internet web sites that provide the goods and/or services the searchers desire.

Yet another feature of the present invention includes a mechanism for enabling an individual and/or a proprietor of an Internet web site to identify goods or services that the individual (and/or proprietor) is desirous to purchase or sell. This feature of the present invention enables an improved mechanism for information to be dispersed over the Internet enabling individuals to purchase or sell a variety of goods and/or services.

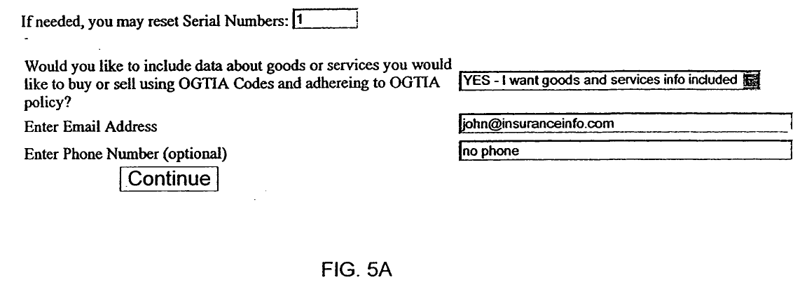

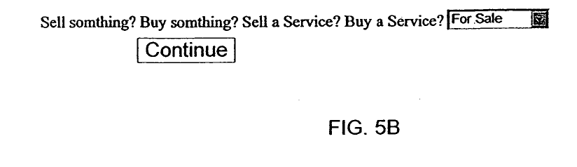

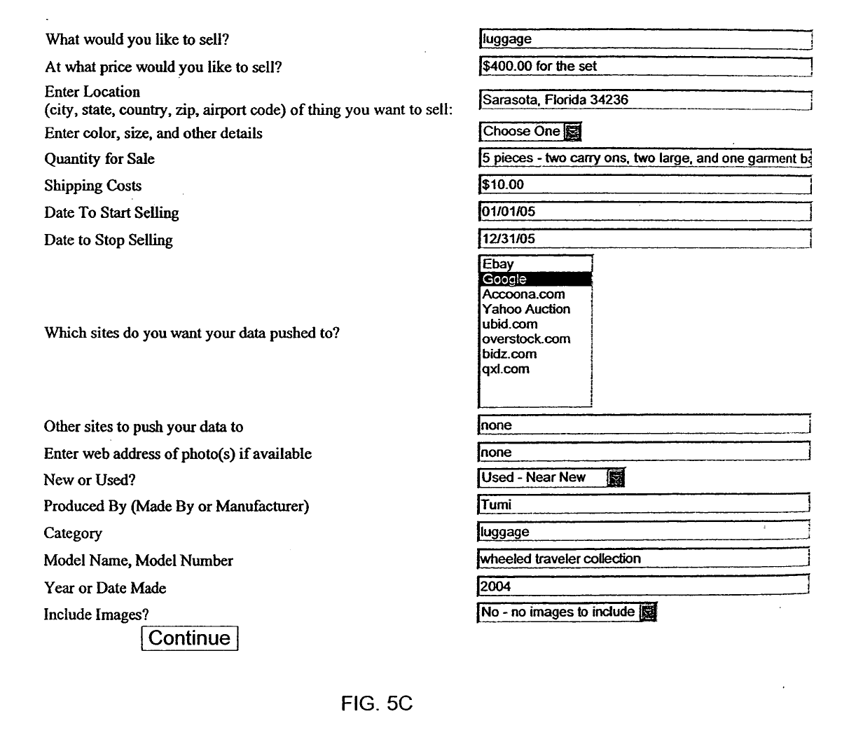

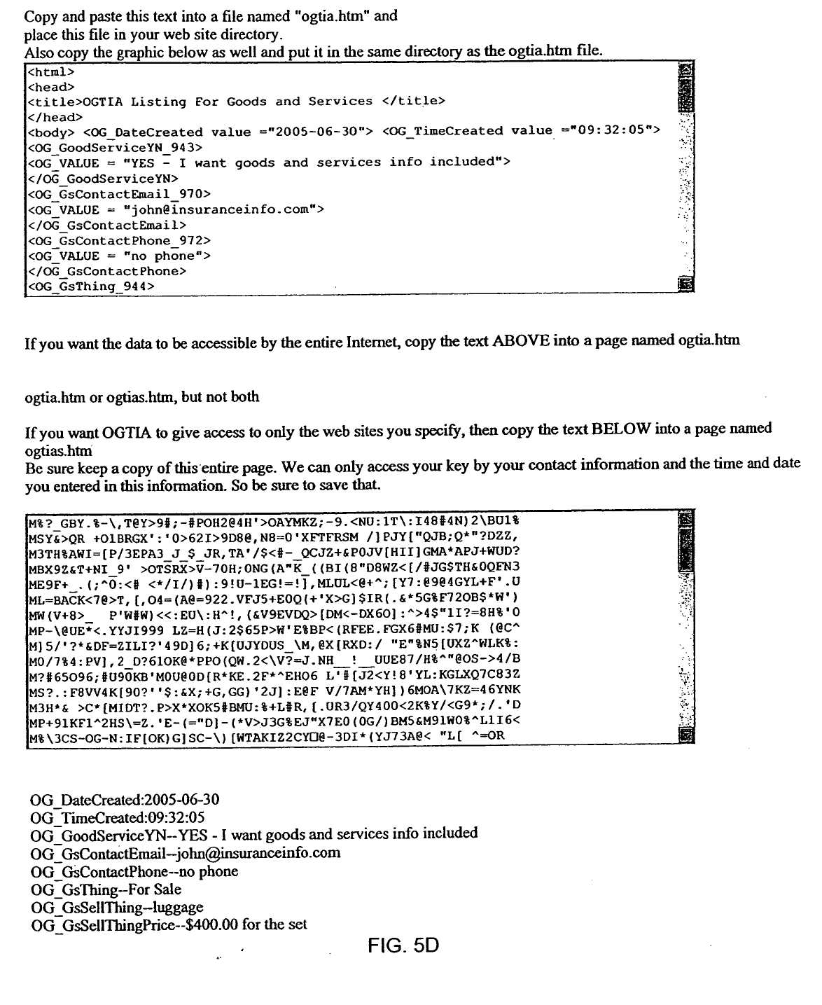

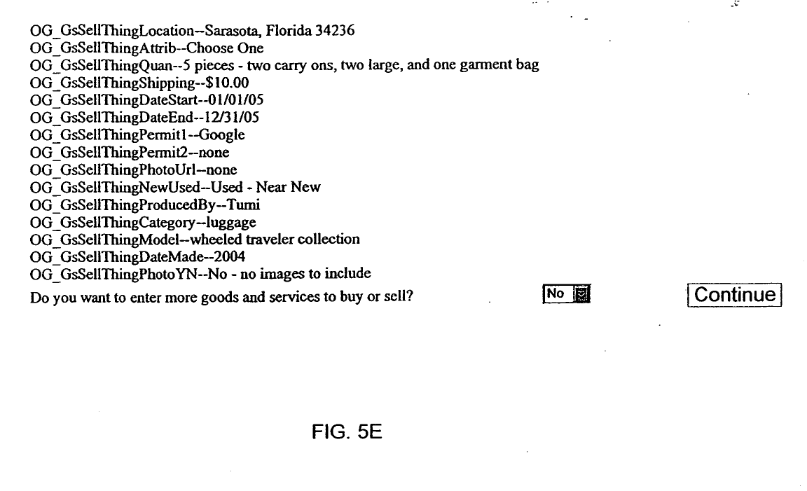

As described above with respect to FIGS. 4A-4F, FIGS. 5A-5E illustrate an example Internet web site provided by the present invention in which an individual establishes a communication session in order to submit information regarding goods and/or services the individual wishes to purchase and/or sell. Also, similar to the features described above with respect to FIGS. 4A-4F, the information submitted by the individual is used to generate programming code, for example, HTML, which is preferably saved with a uniform file name and in a uniformly named directory for convenient access by search engines or other Internet searching technology.

In the example shown in FIGS. 5A-5E, a proprietor of an insurance information web site is desiring to sell his used luggage. As described above with respect to FIGS. 4A-4F, an OGTIA Label is generated which is saved and stored in a uniformly named directory. Although in the following reference to FIGS. 5A-5E, a proprietor is described for responding to prompts provided by the present invention, the invention is not so limited. As noted above, the features provided for example, in FIGS. 5A-5E can be used by any individual desiring to buy or sell a good and/or service. Therefore, the following description with reference to FIGS. 5A-5E that includes discussion of a web site proprietor is not meant to limit or restrict the invention in any way.

In FIG. 5A, the proprietor of the web site is prompted to reset a serial number, if desired. Thereafter, the proprietor is prompted to identify information about the goods and/or services the proprietor would like to buy or sell. Thereafter, the proprietor is prompted to submit an e-mail address and telephone number for enabling another person to contact the proprietor. In FIG. 5B, the proprietor is prompted to identify whether the proprietor wishes to buy or sell some thing or service. In FIG. 5C, the proprietor is prompted to submit information regarding the goods and/or services the proprietor is desiring to buy or sell. In the example shown in FIG. 5C, the proprietor is selling his used luggage for $400.00 for the set. The proprietor further submits a city, state and zip code, is prompted to identify color, size, make, model or other description of the particular goods and/or services. Other information is preferably submitted by the proprietor including the details of the services, the quantities of sale, shipping costs and start and stop dates when the service is available.

Also, as shown in FIG. 5C, the proprietor of the Internet web site preferably identifies web sites that the proprietor would like the information submitted in FIGS. 5A-5C to be made available. In the example shown in FIG. 5C, the proprietor has identified Google.com as target web sites to receive information submitted by the proprietor in FIGS. 5A-5C. Thus, in accordance with a preferred embodiment of the present invention, those Internet web sites identified in FIG. 5C will receive information regarding the submissions in FIGS. 5A-5C. Further, other organizations or web sites the proprietors desire to have access to the information submitted in FIGS. 5A-5C are identified and the web site address of a photo, if available, is further identified in FIG. 5C.

FIG. 5D illustrates the creation of the programming code, shown as HTML in a text box, substantially as described above with reference to FIGS. 4D-4F. The particular programming code that is generated in FIG. 5D relates to the responses to the prompts in FIGS. 5A-5C. In one embodiment of the present invention, the programming code is simply appended to the previous OGTIA Label created in FIGS. 4A-4F. Alternatively, a new OGTIA Label is created specifically for the information submitted in FIGS. 5A-5C.

In the embodiment shown in FIG. 5D, a second text box is provided that includes an encrypted version of the OGTIA Label created in the first text box. As noted above with reference to FIG. 5C, the proprietor (or other user) may identify particular web sites that the proprietor wishes to have access to the data submitted in FIGS. 5A-5C. In order to restrict access to the information and/or to prevent tampering with the information, an encrypted version of the OGTIA Label is generated, as shown in the second text box in FIG. 5D. Those recipients identified by the proprietor who are to have access to the OGTIA Label are preferably provided with a key or other security tool to effectively unlock the encrypted code and gain access to the OGTIA Label. Thus, in accordance with a preferred embodiment of the present invention, the OGTIA Label that is prepared in response to prompts, for example, those shown in FIGS. 5A-5C, can be unlocked by using a key to decode the encrypted OGTIA Label. The bottom of FIG. 5D and the top of FIG. 5E illustrates the responses made by the proprietor to the prompts identified in FIGS. 5A-5C. At the bottom of FIG. 5E, is an additional prompt that enables the proprietor to submit another item or service the proprietor is offering for sale or is desirous to obtain.

Thus, in accordance with the present invention, new techniques are provided for enabling users and searchers over the Internet to identify goods and/or services that are offered by organizations represented by various web sites. For example, iterative processes are defined for searchers and web site administrators to enable accurate searching and listings of web sites. Moreover, one or more web sites are preferably provided to enable web site proprietors, and searchers, to describe web sites, goods and/or services that are either desired or available. Of course, one skilled in the art will recognize that the prompts identified in FIGS. 4A-5E are merely illustrative, and that other prompts can be provided for various kinds of information.

It is noted that the example web site illustrated in FIGS. 4A-4F (e.g., the insurance information web site) and the item for sale 5A-5E (e.g., the used luggage) are unrelated. It is envisioned herein that any web site space can be used to enable one to buy or sell anything, even if the web site is unrelated to that thing. Since web space is already available (e.g., the insurance information site is already established), a benefit the present invention provides is that same web space can be used to buy or sell goods or services, even unrelated goods or services. Thus, and in accordance with the examples in FIGS. 4A-5E, a proprietor can use his insurance information web site to sell his used luggage (or anything else).

Even though the examples depicted in FIGS. 4A-5E represent unrelated subject matter, the invention is not so limited. For example, a retail organization that sells used car parts may have an Internet web site to sell the used car parts. The proprietor of the used car parts web site can use the present invention to sell related items, and can use the present invention to generate HTML code related to each and every item in the retail outlet, if he so desires. Alternatively, the proprietor can generate HTML code using the present invention for only select or individual items. Thus, the present invention is flexible in that proprietors of web sites can use the present invention to generate HTML code for items/services related to their web sites, or items/services that are totally unrelated to their web sites. In either case, the HTML code will be identified by searchers using search engines and/or other Internet content retrieval applications and the on-line marketplace will be enhanced over typical, prior art search and retrieve methods.

In accordance with an embodiment of the present invention, after a proprietor submits information regarding his web site and/or a product/service he wishes to purchase or sell, a message is automatically sent that indicates successful or unsuccessful completion therewith. For example, a telephone call placed to telephone 208 (FIG. 2) is automatically placed by index server 201 that provides a message that indicates the relative success of the proprietor's submission. Alternatively (or in addition), a message is transmitted to fax 210 and/or messaging device 212 that indicates whether the proprietor's submission was successful. The message provided may include prompts for additional information that was omitted during the submission process, and/or may prompt for an additional connection to index server 201 in order to clarify or provide various information.

Of course, one skilled in the art will recognize that any device capable of receiving a message is envisioned herein, and the above-described messaging feature of the present invention is not limited simply to telephones, fax machines and/or messaging devices. E-mail messages may be automatically generated, web pages may be displayed, or messages may be transmitted in any form known in the art.

In a preferred embodiment of the present invention, an error-detection scheme is employed that authenticates the integrity of an OGTIA label. For example, a checksum value is substantially automatically provided based on a number of bits in the message. A receiver can determine, based on the checksum value, whether the OGTIA label has been altered in any way.

In one embodiment, during the generation of the OGTIA label, substantially as described above, the basic components of the OGTIA label are added, such as the bytes, and the result is stored. Thereafter, a recipient of the OGTIA label accesses the checksum and verifies that the OGTIA label is not corrupted by doing an operation on the data, and checking the sum.

As known to those skilled in the art, various types of redundancy checks, such as Fletcher's checksum, Adler-32, and cyclic redundancy checks may be employed by the present invention in order to provide greater degrees of protection from various forms of modification. The present invention supports various forms of redundancy checking, as known to those skilled in the art.

In accordance with the present invention, OGTIA labels can be authenticated to ensure that the integrity of the OGTIA label has not been compromised. For example, the authentication schemes of the present invention discourage a party from simply copying an OGTIA label, for example, from a web site, and manipulating the label. Therefore, the present invention provides assurance to parties that the OGTIA labels they generate via the present invention will not be copied and/or modified for malicious or other undesirable purposes. By providing a checksum or other value, the OGTIA labels can be certified as genuine easily.

Thus, as described above with respect to the generation of HTML or other programming code, the present invention preferably generates code automatically that represents the information input by the proprietor over a web site. In addition, the present invention enables access to the information by restricting access to the web page schemes to restricted parties. In a preferred embodiment, encrypted code is automatically generated and saved by the proprietor with a file name that indicates the code is secured (e.g., OGTIAS.HTM or OGTIAS.HTML.). Thereafter, the proprietor identifies particular Internet web sites that should be allowed access to the encrypted programming code, generated by the present invention.

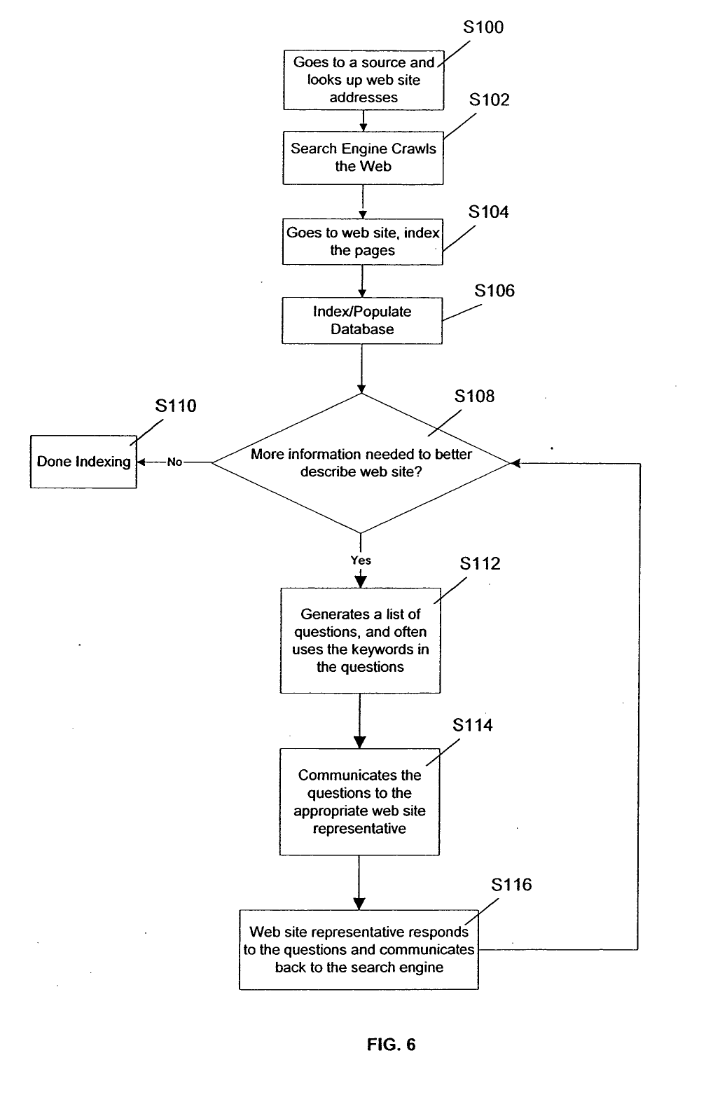

Other uses and products provided by the present invention will be apparent to those skilled in the art. For example, and as described below with reference to FIGS. 6-8, index server 101 is not a necessary feature of the present invention to improve web site features.

FIG. 6 is a flow chart that illustrates steps associated with indexing an Internet web site in accordance with a preferred embodiment of the present invention. At step S100, the present invention establishes a connection with a “source” web site to identify a web site address or registered owner of a web site domain. For example, a connection is made with the well known web site, www.whois.com, to identify administrators and Internet web site addresses, particularly for new Internet registrations. At step S102, the search engine robot (e.g., spider) establishes a communication session with the web site located at that address (e.g., “crawls” to the web site) in step S100. Alternatively, the present invention attempts to communicate directly with the administrator of the respective web site, for example, by e-mail or other icons. Thereafter, the present invention identifies information on the web site, for example, by processes known to those skilled in the art, such as by analyzing the HTML content such as various HTML tags, screen scraping or other methods, in order to retrieve or obtain material regarding the web site (step 104). Thereafter, a record is added to a database that includes, for example, the web site's address (e.g., internet protocol or “IP” address) and descriptive information regarding from the web site. The descriptive information is preferably used to generate an index that can be used, for example, by a searcher to search for the respective web site (step S106).

Continuing with the example flow chart shown in FIG. 6, the descriptive material is analyzed and a determination is preferably made whether more information should be obtained in order to better describe the web site and/or to more accurately represent the web site in response to a keyword search or other forms of searching for the respective web site (step S108). If the result of the determination in step S108 is information that has been obtained sufficiently describes the web site, then the process branches to step S110 and the process ends. Alternatively, if the determination in step S108 is that more information should be obtained, then the process branches to step S112 and one or more questions or prompts are generated for the administrator of the web site. In step S114, the present invention communicates the questions to the appropriate web site representative, e.g., the administrator of the web site (in this example, identified by whois.com). At step S116, the web site representative responds to the questions, for example, by transmitting the response, and the process loops back to step S106, the database is indexed/populated, and, at S108, a determination is again made whether more information should be obtained to describe the web site more accurately. If so, the process repeats steps S112, S114 and S116 until sufficient information is determined to have been received, in which case the process branches to and terminates at step S110. Thus, as described in FIG. 6, the present invention improves classifying and indexing of Internet web sites for search engines, in order to provide searchers with more accurate Internet web site listings.

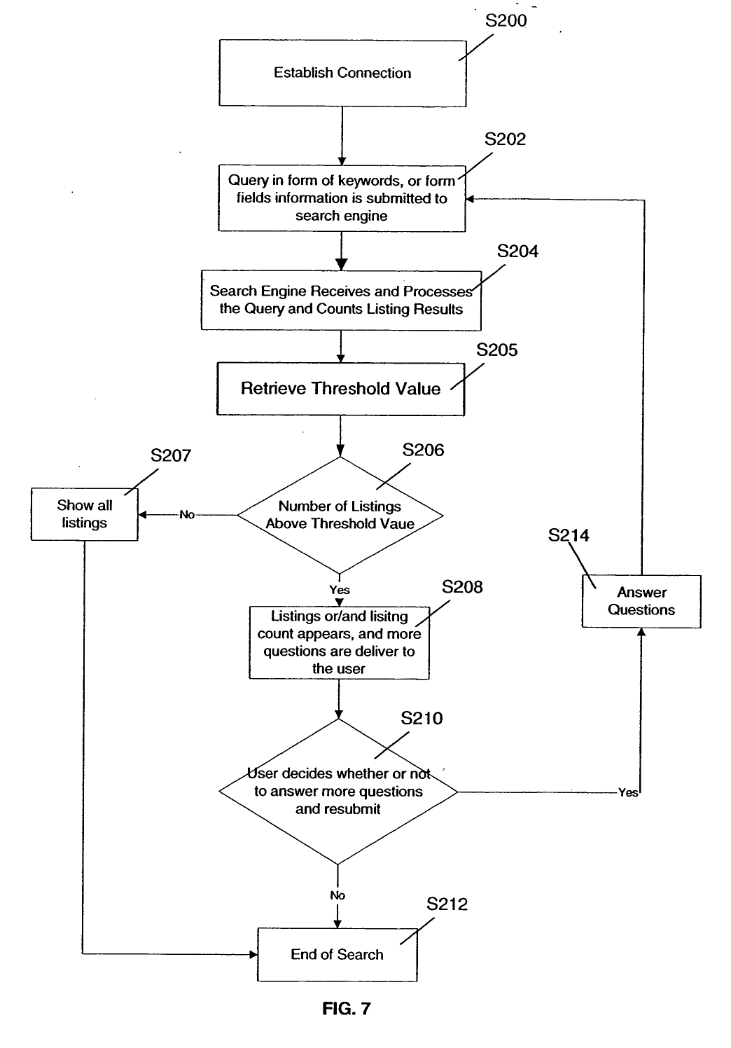

FIG. 7 is a flow chart that illustrates steps associated with searching for web sites in accordance with a preferred embodiment of the present invention. At step S200, a searcher establishes a communication session with a search engine. Thereafter, the searcher submits a query, for example, in the form of keywords that are entered in a graphic screen control, such as a text box, and submits the keywords to the search engine (e.g., via a button control) (step S202). At step S204, the search engine receives and processes the query and counts the number of web sites listed in the result. For example, a search for car parts yields 24,000,000 web sites, each of which includes the term, “car parts.” In step S205, a threshold value is retrieved from a database. The threshold value represents a maximum number of returned web sites in a given search. Thereafter, the present invention preferably makes a determination whether the number of listings that is returned by the query is above the retrieved threshold value (step S206). Continuing with the present example, a listing of 24,000,000 web sites is impractical for a person to review. If the determination in step S206 is that the number of listings is above the threshold value, the process branches to step S208 and the list and/or a value representing the number of web sites returned by the search appears and questions are provided in the search engine for a searcher to refine the search parameters. Alternatively, if the determination in step S206 is that the number of listings is not above the threshold value, then, in step S207, the present invention preferably shows the listings and the process terminates at step S212.

In addition to an automated process that makes a final determination whether the number and/or quality of web sites returned by a search are sufficient, the present invention further enables the searcher to decide whether the number and/or quality of web sites returned by a search are sufficient. In such case, the searcher makes a determination whether he or she wants to respond to additional prompts (step S210). If the searcher does not wish to respond to such prompts, the process ends at step S212. Alternatively, the process branches to step S214 and the searcher replies to the respective prompts posed by the search engine. Thereafter, the process branches back to step S204 and the search engine returns a refined list of web sites. Thereafter, the process iterates a number of times until either the searcher decides that he or she does not wish to reply to more prompts or a number of listings returned by a query is not above the threshold value.

Thus, the present invention ensures that searchers are provided an opportunity to further refine searches for Internet web sites and be provided web site listings that accurately represent the kinds of web sites that the searcher desires.

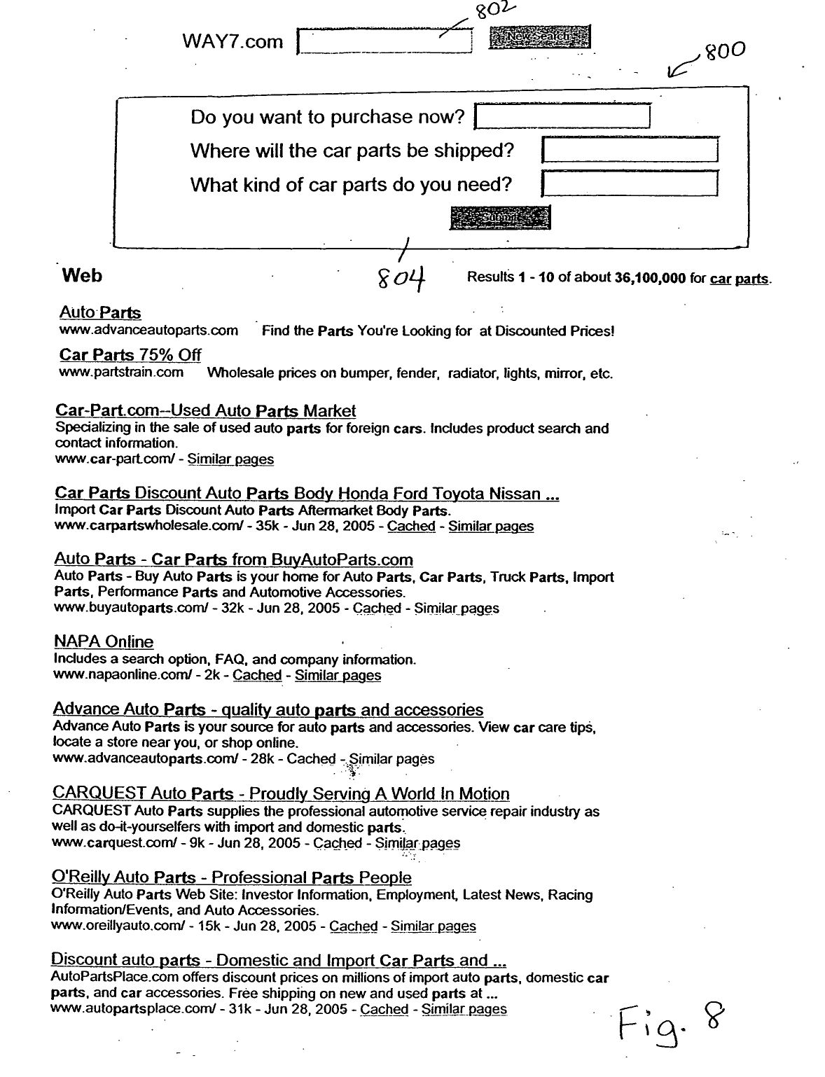

FIG. 8 is an example display screen 800 that is provided to a searcher who is searching for content stored on Internet web pages in accordance with an example embodiment of the present invention. In the example shown in FIG. 8, the searcher used text box 802 to request a listing of Internet web pages that regard car parts. In the example shown, 36,100,000 web pages have been identified and results 1-10 are displayed. In order to refine the number of web sites that are returned by this query, a number of questions are provided to the searcher in block 804. For example, the searcher is asked whether he wants to purchase now and where the car parts will be shipped including a zip code. Further, particular kinds of car parts needed by the searcher is requested. Thus, using the text fields that are provided in display screen 800, the searcher is provided an opportunity to refine the search criteria and reduce the number of web pages that are returned in the listing.

Thus, the present invention improves search engine technology by refining the way that search engines receive and process web site information. Further, the present invention improves ways that searchers search for Internet web sites. Unlike typical search engines that maintain their own databases of which proprietors of web sites cannot typically access, maintain or even view, the present invention enables proprietors of web sites to have control over their listings by creating searchable web sites that are generated in accordance with the teachings herein. The proprietors can repeatedly return to the web site provided by the index server 201 in order to refine and improve the HTML code generated thereby.

Moreover, in the event that a proprietor publishes a web site that is identified by a search engine, in accordance with the iterative search engine listing techniques described herein, the proprietor can be contacted to supply more information regarding his web site to increase and optimize traffic thereto. Also, in a preferred embodiment of the present invention, the proprietor can be contacted by provided a link to indexing server 201 in order to reply to prompts (described with reference to FIGS. 4A-4F) and generate HTML code that accurately and perhaps more aptly describes the proprietor's web site. Further, the HTML code can be saved and stored in such a way as to ensure that searchers for content related to the proprietor's web site will locate the web site, and the proprietor will enjoy far more optimized web traffic that he would otherwise in the prior art.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A method for enabling searchers to locate content stored on an web site, the method comprising:
providing an interface on a workstation, wherein the interface is operable to receive electronic information;
receiving electronic web site information in the interface, wherein the electronic web site information represents the content stored on the web site;
automatically generating computer programming code as a function of the electronic web site information and providing the code to the workstation, wherein the code enables the searchers to locate the content when the code is stored on the web site.

2. The method of claim 1, wherein the interface is provided on an indexing server that communicates with the workstation over a communication network.

3. The method of claim 2, wherein the communication network is the Internet.

4. The method of claim 1, wherein the electronic web site information comprises one or more of:
the web site address;
an indication whether the web site operates to receive electronic financial payments;
an e-mail address;
an indication whether the web site is for profit or not for profit;
an North American Industry Classification System code;
an indication whether the web site includes mature or graphic content;
the language of the web site;
web site security information; and
descriptions of the industry to which the web site pertains.

5. The method of claim 1, wherein the code includes a unique value that indicates the code was automatically generated as a function of the electronic web site information.

6. The method of claim 1, wherein the code is stored in a directory related to an address of the web site

7. A method for enabling a proprietor of a web site to post information related to a good or service the proprietor is looking to buy or sell, the method comprising:
providing an interface to a workstation, wherein the interface is operable to receive electronic information over a communication network;
receiving in the interface electronic posting information, wherein the electronic posting information represents at least the good or service that the proprietor is looking to buy or sell;
automatically generating computer programming code as a function of the electronic posting information and providing the code to the workstation, wherein the code provides the information to be posted and enables searchers offering to sell or buy the good or service to locate the proprietor.

8. The method of claim 7, wherein the communication network is the Internet.

9. The method of claim 7, wherein the posting information represents one or more of:
the name of good or service the proprietor would like to buy or sell;
details of the good or service the proprietor would like to buy or sell; and
names of web sites where the proprietor would like the data sent.

10. A method for improving how a web site is listed by an Internet search engine, the method comprising:
identifying a location of a web site;
establishing a communication with the web site and obtaining information about the web site;
using the information to make a first entry in a database regarding Internet web sites;
determining whether additional information should be obtained to more particularly represent the web site;
generating at least one prompt for the additional information;
providing the at least one prompt to a proprietor of the web site;
receiving a reply to the at least one prompt;
and using the reply to make a second entry in the database or to refine the first entry in the database.

11. The method of claim 10, further comprising repeating the steps of determining whether additional information should be obtained, generating at least one prompt for the additional information, providing the at least one prompt to the proprietor, receiving a reply to the at least one prompt; and using the reply to make a third entry or to refine the first entry in the database until determining that additional information should not be obtained.

12. A method for enabling a searcher to locate content on an Internet web site using a Internet search engine, the method comprising:
receiving in the search engine a query from the searcher for the content;
processing the query by matching the query with listings in a database of Internet web sites and providing the matched listings to the searcher in the search engine;
referencing a threshold value and determining whether the number of listings returned by the processed query is higher than the threshold value;
generating at least one prompt for additional information and providing the at least one prompt to the searcher; and
using a reply from the searcher to the at least one prompt to refine the query and processing the refined query when the user elects to reply.

13. The method of claim 12, further comprising repeating the steps of referencing a threshold value, determining whether the number of listings returned by the processed refined query is higher than the threshold value, generating at least one prompt for additional information and providing the at least one prompt to the searcher, and using a reply from the searcher to the at least one prompt to further refine the query, and processing the further refined query when the user elects to reply.
